(19) United States
(12) Patent Application Publication
(10) Pub. No.: US 2016/0270542 A1
(43) Pub. Date: Sep. 22, 2016

(54) Spectator Tray

(71) Applicant: Robert Foster, Palm Desert, CA (US)

(72) Inventor: Robert Foster, Palm Desert, CA (US)

(21) Appl. No.: 14/663,305

(22) Filed: Mar. 19, 2015

(51) Int. Cl. A47C 7/70; A47C 1/12; G09F 23/08; G10K 11/22; G09F 23/00; A47B 13/16; G10D 15/00

(52) U.S. Cl. CPC A47C 7/70; A47B 13/16; A47C 1/12; G10D 15/00; G10K 11/22; G09F 23/00; G09F 23/08; G09F 2023/0025; B29C 45/1679

(57) ABSTRACT

A spectator tray that has a drink receptacle and a snack receptacle. The drink receptacle is sized to be positioned in an opening, such as in an arm member of a spectator seat. The snack receptacle extends outward from the drink receptacle in a cantilevered fashion. The spectator tray further includes a removable cover member adapted to cover the snack receptacle. The spectator tray is adapted to receive accessories such as noise makers, horns, and a pole for use when mounting the tray into the ground. The spectator tray may be used in conjunction with a mounting device that engages with an adjacent seat. The spectator tray can be formed from a plastic material injection molded to include advertising images on surfaces thereof.

### CROSS-REFERENCE TO RELATED APPLICATIONS

This application claims the benefit of U.S. Provisional Application No. 61/510,635 filed Jul. 22, 2011; and U.S. Utility application Ser. No. 13/554,920 filed Jul. 20, 2012, which are hereby incorporated by reference herein in its entirety.

### BACKGROUND OF THE INVENTION

1. Field of the Invention

The present invention relates to containers used by spectators in sporting and entertainment venues and, in particular, trays used to contain drinks, food, and advertising, and that may also have additional accessories attached thereto.

2. Description of the Related Art

In many different entertainment venues, e.g., sporting venues, theaters, etc., it is not uncommon for spectators to purchase drinks and snacks. One difficulty with such purchases though involves carrying the drinks and snacks from the point of purchase to the viewing area and then securely retaining the drinks and snacks at the viewing area. This problem is often compounded when the spectator is also purchasing accessory items, such as noise makers, signs or other items used to demonstrate enthusiasm for the sporting event or entertainment.

Typically, in existing sporting and entertainment venues, when a spectator purchases drinks or snacks, the best carrying container that is provided is a cardboard carrying container that is flimsy and typically ends up as trash. This type of carrying container also does not accommodate noisemakers, or other items used by spectators to show enthusiasm.

Moreover, there is often a lack of places to adequately store the carrying container at the seat location. Typically, the carrying container with the food and beverages ends up on the floor where it is not accessible to the spectator and is in danger of being tipped over and the like.

Hence, there is a need for a carrying device that is more versatile for spectators. To this end, there is a need for a carrying device that is more permanent and allows a spectator to carry food, drink and other accessories and also allows the carrying container to be stored at the seat location in a more accessible manner.

### SUMMARY OF THE INVENTION

The aforementioned needs are satisfied by the spectator tray of the present invention which, in one implementation, includes a receptacle that is sized so as to receive a drink and a receptacle that is sized so as to receive snack items. The spectator tray may further include a removable cover member adapted to cover the snack receptacle during transport. The spectator tray of this implementation further includes at least one spectator accessory that is attached thereto. The spectator accessory can include a noisemaker such as cymbals, bells, etc. The spectator accessory may also include a speaking tube that is mounted to the drink receptacle on the bottom side so that the spectator tray can be simultaneously used to carry a drink and also carry the speaking tube. The spectator tray is formed from a plastic material molded to include advertising images on surfaces thereof. This is accomplished by injection molding plastic material into a mold and having advertising members inserted therein. A two portion mold and an automated robotic machine are generally used to create the spectator tray.

In one implementation, the drink receptacle is sized so as to fit into a drink receptacle in a chair in the spectator area. In this implementation, the drink can be retained in the spectator tray and the tray can be pivotally mounted in a seatside drink receptacle providing easy access for the spectator to the food items carried in the tray as well as any other spectator accessory. As the tray is pivoted the user can more easily sit in the chair and then pivot the tray closer to them and in position for eating and drinking. Further, the spectator tray may include a removable cover member adapted to cover the snack receptacle so as to hold and contain snack members therein while transporting to the chair in the spectator area.

In some implementations, the spectator area may be a movie theater and the drink can then be sized to be positioned in the theater seating. In some implementations, information, logos etc. can be formed on the tray as advertising for the movie theater or other advertisers.

In one implementation, an accessory may be sold with the tray that engages with the drink receptacle so as to form a pole onto which the spectator tray may be mounted. The pole may then facilitate use of the spectator tray by positioning the pole into the ground thereby suspecting the spectator tray above the ground in areas, such as the beach, etc. where seatside drink receptacles are not available.

In another implementation, the spectator tray may include or be used in combination with a mounting device that engages with the armrest of a seat in front of the spectator seat. In this implementation, the mounting device includes a receptacle that allows for the spectator tray to be positioned in the receptacle and extend backwards in a cantilevered fashion. In one specific implementation, the mounting device includes a first arm that extends outward from the receptacle member. The first arm includes a flange that engages the front portion of the seat in front of the spectator and a second arm that engages with the back of the arm rest of the seat in front of the spectator so that the receptacle for the spectator tray is retained in a cantilevered fashion. This results in the spectator tray or, alternatively a drink, being positionable into the mounting device and thus positioned at about arm level of the spectator thereby improving access and reducing the likelihood that the drink or food in the spectator tray will be spilled on the ground.

These and other objects and advantages of the present invention will become more apparent from the following description taken in conjunction with the accompanying drawings.

### BRIEF DESCRIPTION OF THE DRAWINGS

FIGS. 1A and 1B are top perspective views of one embodiment of a spectator tray;

FIG. 2 is a bottom perspective view of the spectator tray of FIG. 1;

FIG. 3 is a bottom exploded perspective view of the spectator tray of FIG. 1;

FIG. 4 is a side perspective view of the spectator tray of FIG. 1;

FIG. 5 is a top perspective view of the spectator tray of FIG. 1 using an accessory pole mounting device;

FIG. 6 is a perspective view of a mounting device that can be used either with the spectator tray of FIG. 1 or with a drink.

FIG. 7 is a perspective view of how the mounting device can be used with a seat in front of the spectator's seat;

FIG. 8 is a perspective view of how the spectator tray of FIGS. 1A and 1B can be used with the mounting device of FIG. 6; and

FIG. 9 is a perspective view of the mounting device of FIG. 6 being used with a cup.

FIG. 10 is top perspective views of one embodiment of the spectator tray including a cover member attached thereto, and showing positions of advertising members included on surfaces thereof;

FIG. 11 is a top perspective view of the spectator tray of FIG. 10 with the cover member separated therefrom, and showing more positions of advertising members included on surfaces thereof;

FIG. 12 is a cross-sectional view of the spectator tray of FIG. 11 along line 3-3 and showing edges of the cover member used to releasably attach thereto;

FIG. 13 is a cross-sectional of the spectator tray of FIG. 10 along line 3-3 and showing edges of the cover member releasably attached thereto;

FIG. 14 is a top perspective view of the spectator tray of FIG. 10 and showing a drink member being placed within the drink receptacle;

FIG. 15 is a perspective view of the two halves of the spectator tray mold separated and the resulting spectator tray being removed;

FIG. 16 is a second perspective view of the two halves of the spectator tray mold separated and the resulting spectator tray being removed;

FIG. 17 is a perspective view of the automated injection molding machine adapted to also inject advertising members upon said molded item.

### DETAILED DESCRIPTION OF THE PREFERRED EMBODIMENT

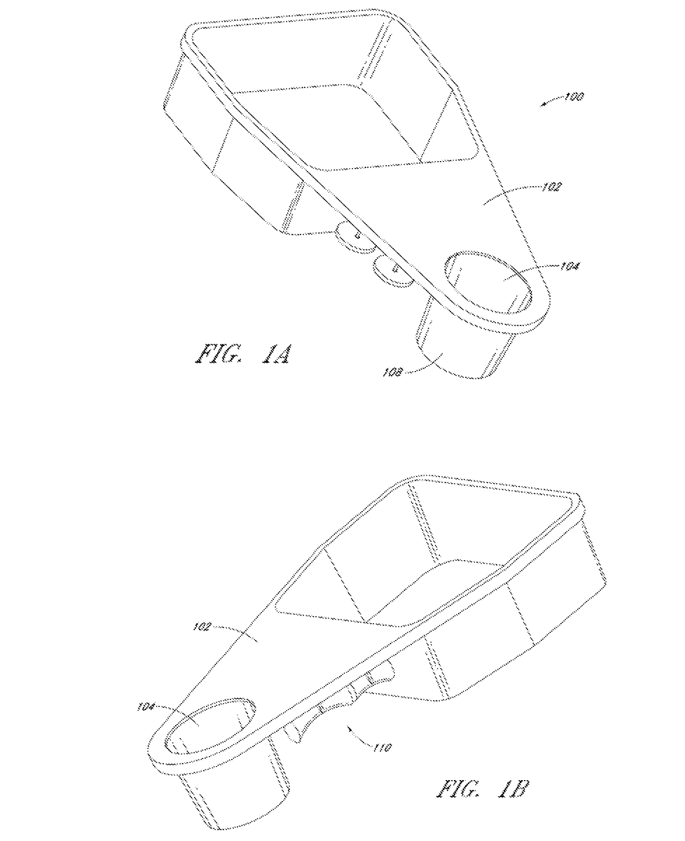

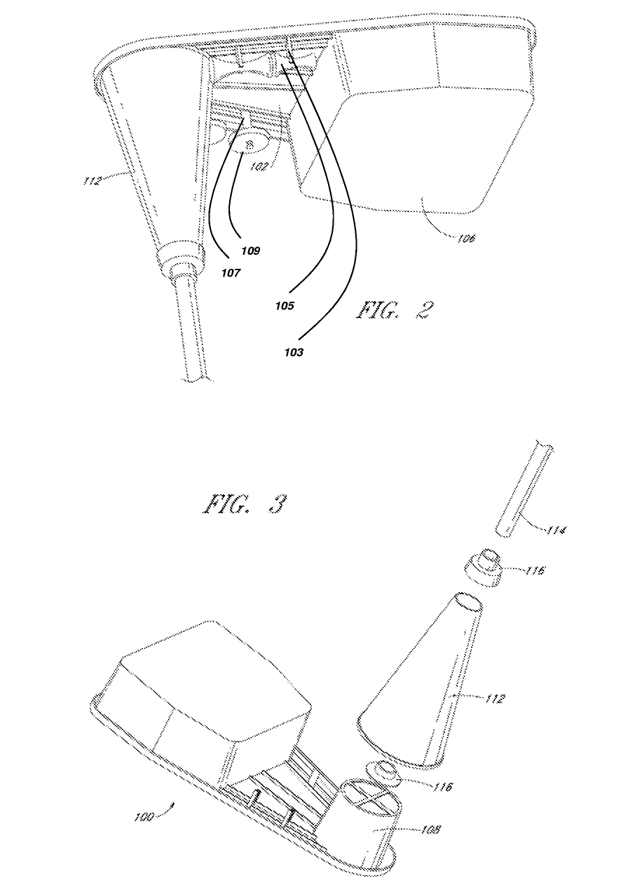

Reference will now be made to the drawings wherein like numerals refer to like parts throughout. Referring to FIGS. 1A and 1B an embodiment of the spectator tray 100 is illustrated. In this embodiment, the spectator tray 100 includes a base structure 102 that defines a drink receptacle 104 and a snack receptacle 106. The drink receptacle 104 is generally cylindrical and sized so as to receive a cup or other cylindrical container. The bottom 108 of the drink receptacle 104 extends downward from the base 102 a pre-selected distance that allows the spectator tray 100 to be mounted in a seatside drink receptacle of the type found in seats in movie theaters, sporting venues and the like. Thus, the drink receptacle 104 not only receives a cup or other drink container but can also be used for mounting the tray 100 to another structure.

When so mounted, the snack receptacle 106 is positioned so as to be accessible to a spectator which alleviates the need for the spectator to hold the snacks in their lap or position the snacks on the ground, and wherein the spectator tray includes a tapered surface between the drink receptacle 104 and the snack receptacle 106 such that pivoting the tray with respect to the seatside drink receptacle is easier than prior art trays since it can be rotated further without contacting the torso of the person sitting in the seat. While the receptacle 106 is described as a snack receptacle, it will be appreciated that any of a number of items, other than snacks, can be stored in the snack receptacle 106 without departing from the spirit of the present invention.

As is also shown, the tray 100 may also include one or more accessories 110. These accessories can include such things as cymbals, bells, horns and the like that allow the spectator to demonstrate their enthusiasm for the event they are observing. These devices 110 are also shown in FIG. 2 and can be secured to the bottom side of the base 102 via flush fit plastic retainers and the like in a manner known in the art.

More specifically, as shown in FIG. 2, mounting members 103 having receptacles may be used to receive bells 105 via friction fit. Similarly, cymbal type devices 107 may be permanently or detachably positioned on the posts 109 also by friction fit. In this way, noise making accessories can be included on the tray 100 and can be carried via the tray thereby reducing the encumbrances to the spectator.

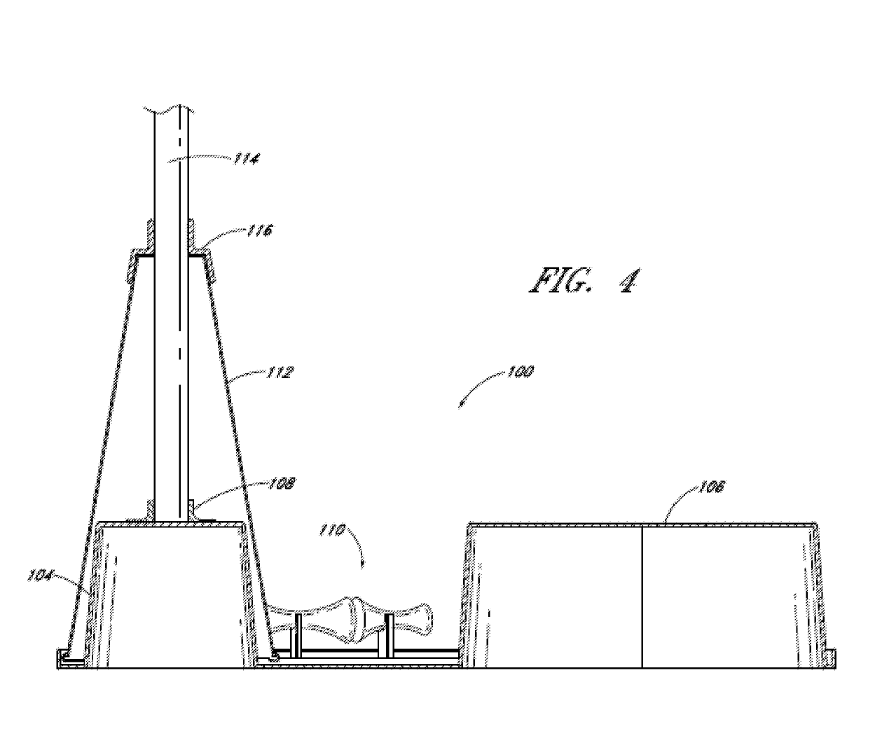

As is also shown in FIGS. 2 and 3, a speaker tube or horn 112 can also be mounted on the drink receptacle 104 and retained in this position also by friction fit or by a retainer of a type known in the art. The speaking tube 112 and the accessories 110 can thus be part of the tray 100 when the tray is sold so that a spectator purchasing the tray can easily carry the accessories 110 and horn 112 while also simultaneously carrying drinks and snacks with the tray 100.

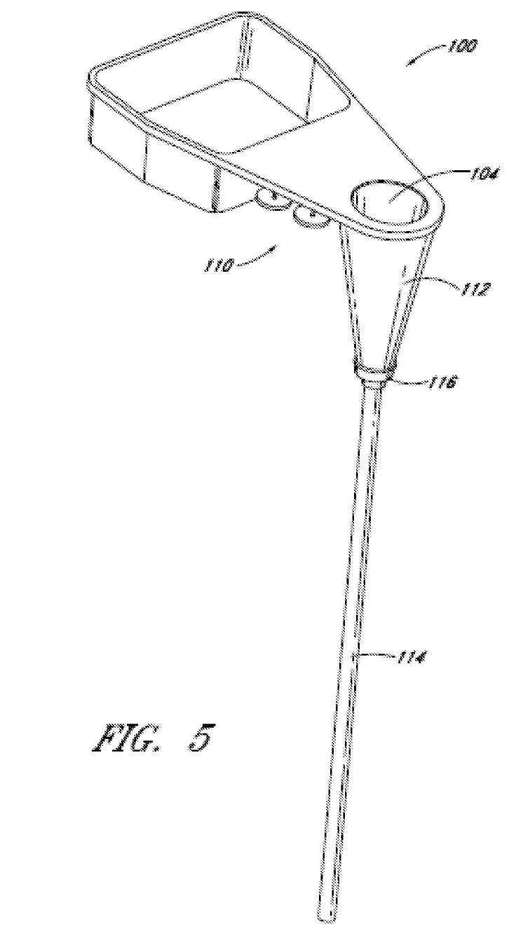

FIGS. 2-5 also illustrate that the tray 100 may also be either equipped or used with an accessory pole 114. The pole 114 engages with the speaking tube 112 and the cup receptacle 104 via retainers 116 and the bottom of the drink receptacle 108 functioning as an anchor receptacle so that the pole 114 can be securely fastened to the tray 100. The pole 114 can then be mounted in the ground thereby providing a means for securing the tray 100 in a surface so as to be elevated from the surface in the manner shown in FIG. 5. It will be appreciated that the pole 114 will be beneficial in venues or locations where there are not receptacles that will receive the drink receptacle 104 in the manner described above. This permits the tray to be used in places like the beach, parks and the like.

The tray 100 can be sold with insignia associated with a particular sporting team, a corporate logo, etc. The tray 100 is preferably made a durable material, such as plastic, including recycled polypropylene, thereby allowing the tray 100 with the accessories 110 and speaking tube 112 to be used over and over again.

Hoops, rings and the like may also be mounted to the underside of the tray 100 like, for example, about the drink receptacle 104 or the speaking tube 112. The rings can then be used as part of a game, where the rings could be tossed over the pole 114 when, for example at a beach or park type setting.

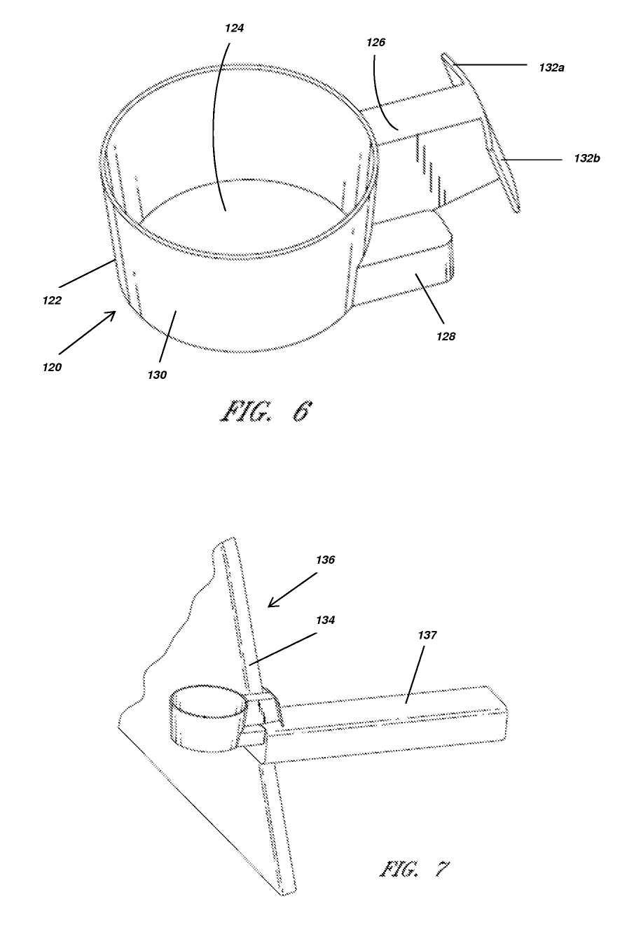

As is also shown in FIGS. 6-8, the spectator tray 100 may also be used in conjunction with a mounting device 120. The mounting device 120 is preferably designed to engage with the seat immediately in front of the spectator's seat and provide a location where the spectator tray 100 can be mounted in an accessible location to the spectator. The mounting device 120 includes a cylindrical member 122 that defines a cylindrical opening 124 that in one embodiment is sized to receive the cylindrical drink receptacle 104 of the spectator tray 100. In another embodiment, the opening 124 may be sized to only receive a cup.

The cylindrical member 122 has two arms 126 and 128 attached thereto so as to extend radially outward from the exterior surface 130 of the cylindrical member 122. The first arm 126 is a seat engagement arm that includes flanges 132a, 132b that are sized so as to engage with the backrest 134 of the seat 136 immediately in front of the spectator. The arm 126 is preferably sized so as to extend a distance sufficiently to allow the cylindrical member 122 to be positioned behind the seat 136. The second arm 128 is preferably radially offset from the first arm 126 and engages with the back 135 of the arm rest 137 of the seat 136. The second arm 128 thus provides stability and support and opposes the downward force exerted on the cylindrical member 122 when the spectator tray 100 or a drink cup is positioned in the opening 124.

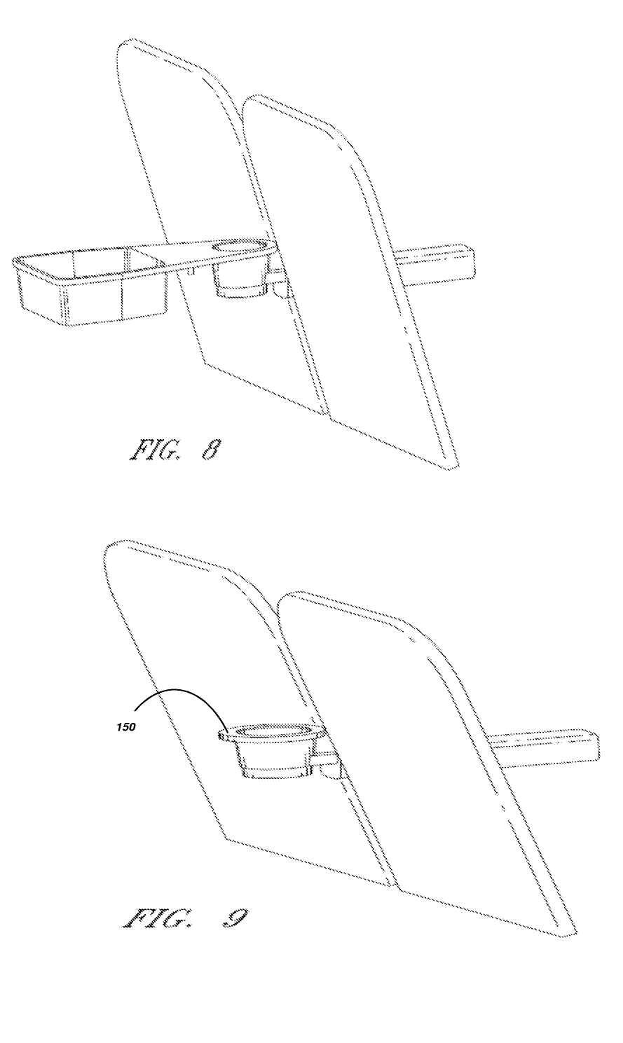

The exact positioning and sizing of the arms 126, 128 can, of course, vary depending upon the seat configuration and they may, in fact, be adjustable to accommodate different seat configurations. As is shown in FIG. 8, the spectator tray 100 can be mounted at a convenient height for the spectator. The only portion of the seat 136 that is occupied by the mounting device 120 is a small portion of the backrest 134 that receives the flange 132a or 132b and the back portion of the arm rest 137. Preferably the flange 132a, 132b are designed to be flat so as to be flush with the backrest 134 so as to not disturb the spectator using that seat. Similarly, the portion of the arm rest 137 that has the arms 126, 128 positioned adjacent thereto is the portion that is between the seats which is generally not used by the spectator in the seat 136. Consequently, the mounting device 120 permits the tray or drink to be supported in front of the spectator with little inconvenience to a spectator occupying the front seat 136.

As is shown in FIG. 9, the mounting device 120 can also be sized to receive a cup 150 as opposed to the spectator tray 100. As the drink receptacle 104 of the spectator tray 100 is already sized to receive a cup 150, sizing the opening 124 to receive the drink receptacle of the spectator tray 100 will result in the opening also being sized to receive a drink cup.

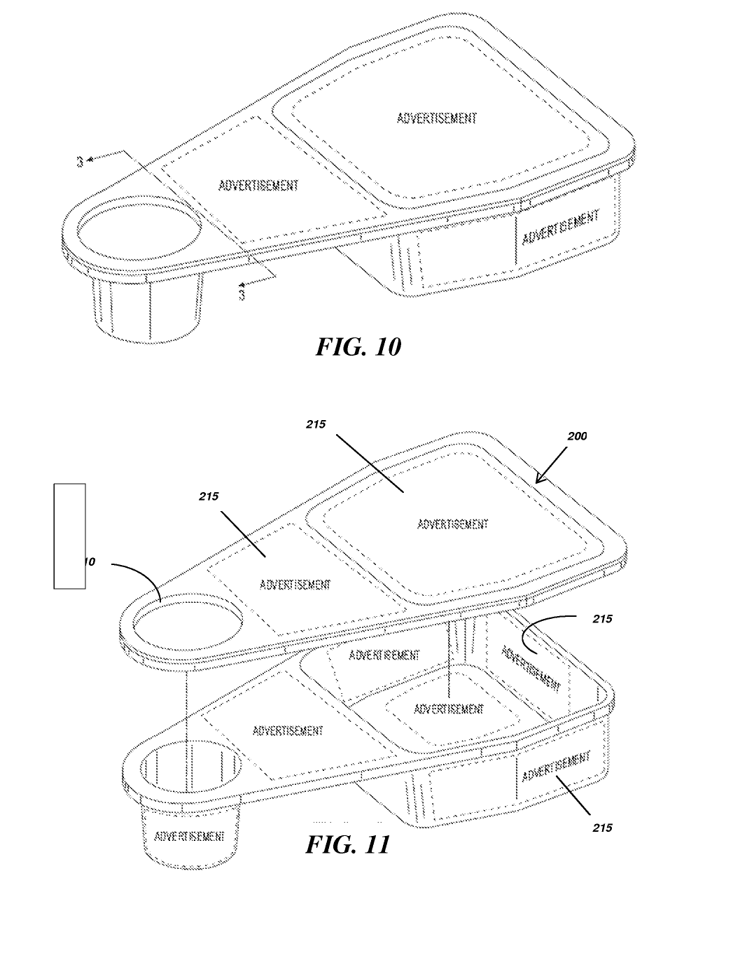

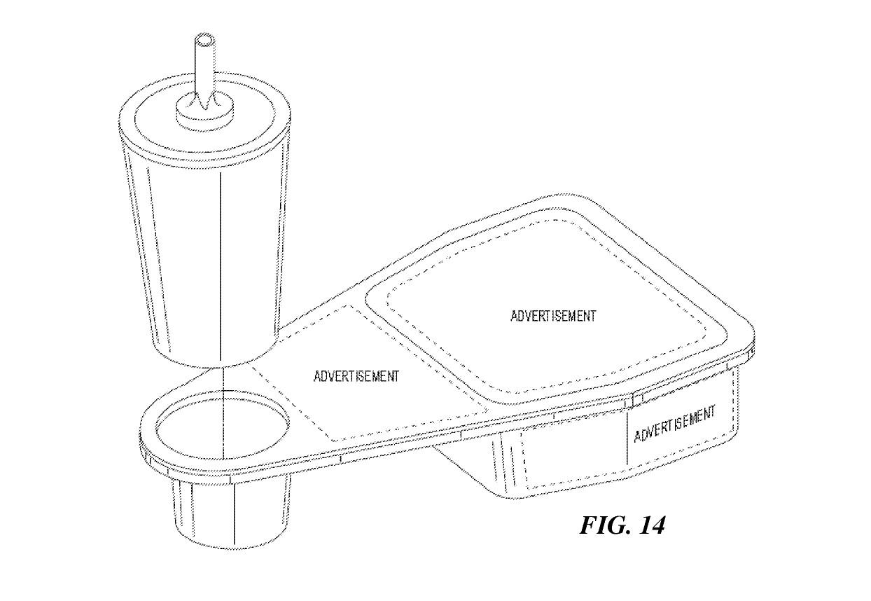

As is shown in FIGS. 10, 11, and 14, a cover member 200 can be included that is formed from a plastic material and which includes a drink receptacle orifice 210, and is shaped and adapted to securely and releasably attach to and cover a top surface area of said snack member portion and encircles the upper perimeter of said drink receptacle, such that when a drink cup is placed within said drink receptacle and said cover member is detached from said snack member portion it can pivot around said drink cup and uncover said top surface area of said snack member portion. The cover member is also adapted to include advertising members therein and thereon to provide for commercial advertising.

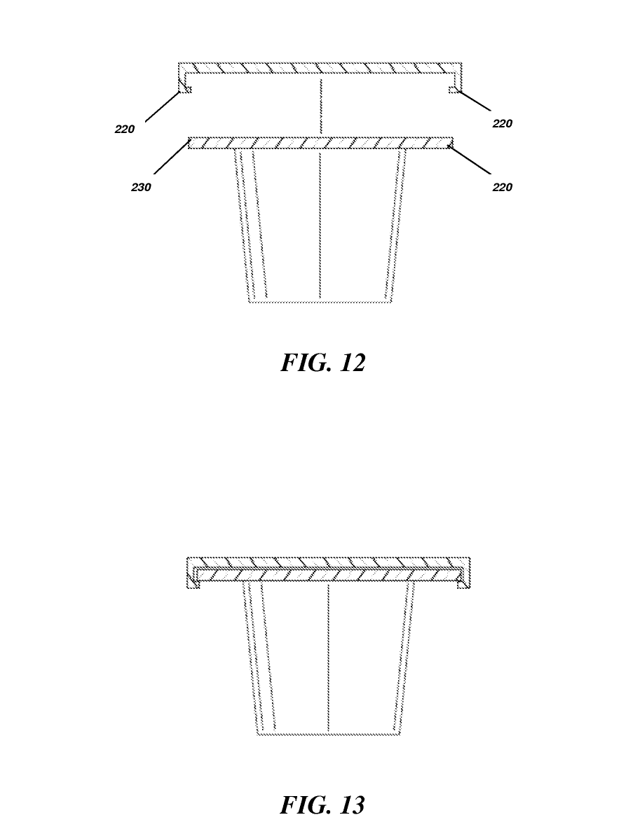

As is shown in FIGS. 12 and 13, the cover member includes at least one flexible attachment portion 220 adapted to securely and releasably hold said cover member to a rim portion 230 of the snack member portion, to thereby form a seal between said cover member and said snack member portion that is adapted to hold snacks and food members securely within said snack receptacle. Flexible attachment portions 220 can be formed as finger manipulatable plastic tabs that can be forced onto or off of the rim portion 230 of the snack member portion when desired to either seal or open the snack receptacle. Other forms of releasable tabs as known in the art can be incorporated as well. In another embodiment, the at least one flexible attachment portion 220 can be formed completely around the outer edge of said cover member, and said rim portion is formed completely around the outer edge of said spectator tray, such that a resulting seal is obtained around the entire spectator tray's circumference.

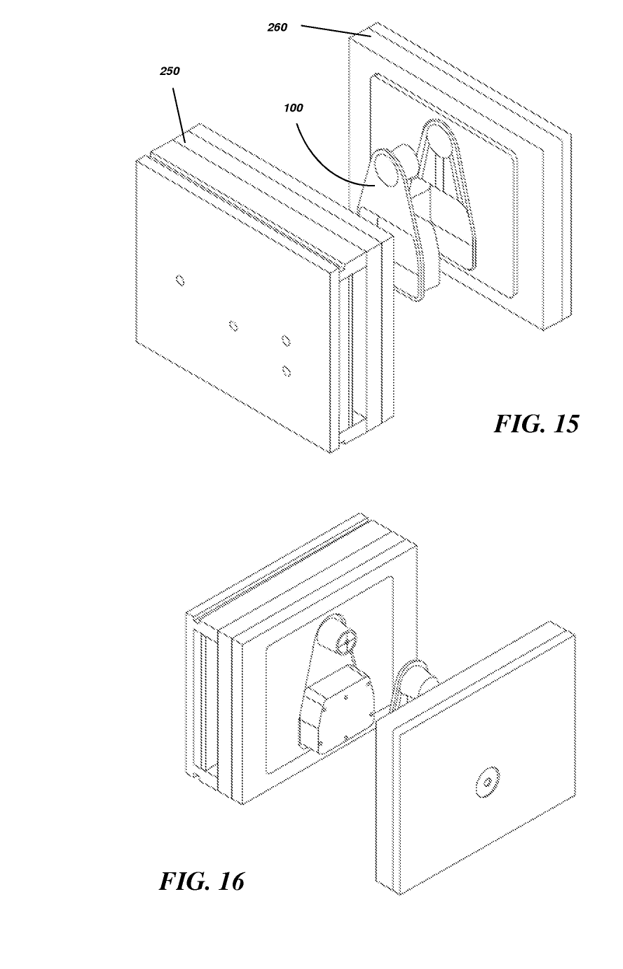

As is shown in FIGS. 15 and 16, a method of forming the spectator tray is illustrated wherein a mold is used for injection molding the spectator tray. The mold includes two halves 250 and 260, such that when pressed together form the shape of the desired spectator tray 100. In a preferred embodiment, the spectator tray is injection molded using a polypropylene material that is easily recycled and can be used to form a new spectator tray after the previous spectator tray has been used and discarded.

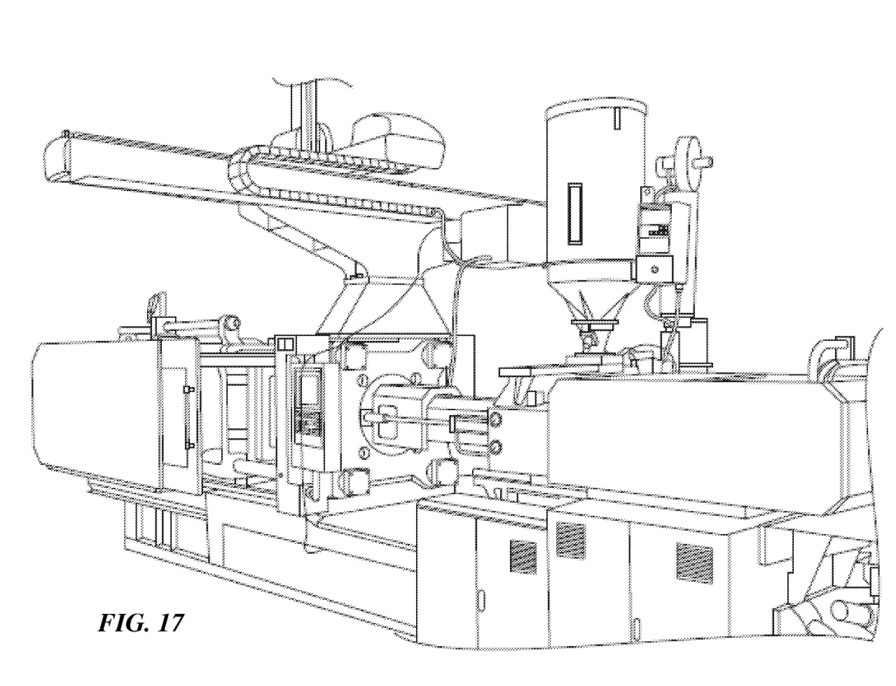

As is shown in FIG. 17, a preferred manufacturing machine 300 is used to injection mold the spectator tray and is automated using robotic elements and controls as known in the art, and is adapted to provide and insert advertising members 215 into the mold during the molding process, such that when complete the spectator tray has embedded therein in selected areas advertising insignias or images for advertising commercial products. In a preferred embodiment, the advertising members are formed as a substrate of polypropylene material that is adapted to be placed either upon or into the outer surface layer of the spectator tray in any of a plurality of locations via the manufacturing machine. The choice of polypropylene for both the spectator tray and the advertising members increases the ease to which these items can be recycled together, streamline the production process, and lower production costs.

It will be appreciated that various changes and modifications to the form and use of the above-described embodiments of the present invention can be made by those skilled in the art without departing from either the spirit or scope of the present invention. Hence, the scope of the present invention should not be limited to the foregoing discussion but should be defined by the appended claims.

1. A spectator tray assembly adapted to be used in conjunction with a spectator seat that includes an arm member having an opening adapted to receive a drink cup, said assembly comprising a spectator tray including:
a drink member portion including a drink receptacle defining a recess sized to receive said drink cup, wherein said recess has an exterior surface that is sized so as to be positioned within said opening of said arm member of said spectator seat; and
a snack member portion that extends outward from said drink member portion such that said snack member portion is adapted to extend outward in a cantilevered fashion from said opening of said arm member of said spectator seat when said drink receptacle is positioned within said opening; and wherein said snack member portion defines a snack receptacle having a first width, and said drink member portion having a second width that is less than said first width of said snack receptacle; and wherein said snack member portion is attached to said drink member portion via a horizontally tapered planar surface of said snack member portion that is adapted and shaped to allow pivotal movement of said tray assembly with respect to said opening of said arm member of said spectator seat while a person is sitting in said spectator seat without contacting the torso of said person sitting in said spectator seat.

2. The assembly of claim 1, wherein said snack member portion has a first and a second side and wherein said snack receptacle is formed as part of said first side, and wherein said horizontally tapered planar surface is formed as part of said second side.

3. The assembly of claim 2, further comprising a plurality of accessories that are mounted on a bottom surface of said second side of said snack member portion.

4. The assembly of claim 3, wherein said plurality of accessories includes bells and cymbals.

5. The assembly of claim 1, further comprising a speaking horn that is adapted to be mounted on said exterior surface of said drink receptacle.

6. The assembly of claim 5, further comprising a pole member, wherein said speaking horn is adapted to be removably engaged with an end of said pole member to thereby allow said tray assembly to be mounted in the ground via said speaking horn and said pole member.

7. The assembly of claim 1, further comprising a mounting device that is adapted to provide a mounting location for said spectator tray.

8. The assembly of claim 7, wherein said mounting device includes a receptacle member that defines said opening adjacent said spectator seat that receives said drink receptacle.

9. The assembly of claim 8, wherein said mounting device includes at least one arm that is adapted to removably and securely engages with a backrest of an adjacent spectator seat so that said receptacle member is removably and securely positioned behind said adjacent spectator seat and is accessible to said spectator seat.

10. The assembly of claim 9, wherein said at least one arm includes a first arm portion that has flanges that are adapted to engage with a front surface of said back rest of said adjacent spectator seat and a second arm that is adapted to engages with a back surface of an arm rest of said adjacent spectator seat so as to support said mounting device and said spectator tray extending backwards from said receptacle member of said mounting device in a cantilevered fashion.

11. The assembly of claim 1, further comprising a cover member shaped and adapted to cover a top surface of said snack member portion and encircle the upper perimeter of said drink receptacle, such that when a drink cup is placed within said drink receptacle said cover member further encircles and can pivot around said drink cup.

12. The assembly of claim 11, wherein said cover member includes at least one attachment portion adapted to securely and releasably hold said cover member to said snack member portion, to thereby form a seal between said cover member and said snack member portion that is adapted to hold snacks and food members securely within said snack receptacle

13. The assembly of claim 1, further including at least one advertising member positioned upon a surface of said spectator tray and is adapted to project an advertising image for a commercial product.

14. The assembly of claim 13, wherein an advertising member is positioned upon an upper surface of said spectator tray, and an advertising member is positioned upon at least one side surface of said spectator tray.

15. The assembly of claim 11, further including at least one advertising member positioned upon a surface of said cover member and is adapted to be used to project an advertising image for a commercial product.

16. The assembly of claim 1, wherein said spectator tray is formed from polypropylene.

17. A method of forming a spectator tray assembly with advertisements formed therein, comprising the steps of:
a. providing a mold having the desired interior mold shape of said spectator tray as set forth in claim 1;
b. injecting a plastic material into said mold;
c. in-mold injecting at least one label member into said injected plastic material;
d. retrieving said spectator tray from said mold.

18. The method of forming a spectator tray assembly with advertisements formed therein as set forth in claim 17, further comprising the steps of:
e. attaching a plurality of accessories to a bottom surface of said snack member portion; wherein said plurality of accessories includes bells and cymbals;
f. providing a pole member and a speaking horn that are adapted to be mounted on said exterior surface of said drink receptacle, and used to mount said spectator tray to the ground.

19. The method of forming a spectator tray assembly with advertisements formed therein as set forth in claim 17, wherein said plastic material includes polypropylene.

20. The method of forming a spectator tray assembly with advertisements formed therein as set forth in claim 19, wherein said at least one label member is formed from polypropylene.
